(19) United States
(12) Patent Application Publication
(10) Pub. No.: US 2003/0101706 A1
(43) Pub. Date: Jun. 5, 2003

(54) Lawn equipment blade and blade system with secondary cutting surfaces

(76) Inventor: Mark Kenny, Jensen Beach, FL (US)

Correspondence Address: TANGENT LAW GROUP, 1201 PENNSYLVANIA AVE, WASHINGTON, DC, 20004, US

(21) Appl. No.: 10/307,440

(22) Filed: Dec. 2, 2002

Related U.S. Application Data
(60) Provisional application No. 60/334,610, filed on Dec. 3, 2001.

(51) Int. Cl. A01D 34/73

(52) U.S. Cl. 56/255; 56/295

(57) ABSTRACT

A cutting blade is provided having a blade body with a primary cutting surface and a direction of rotation. There is at least one secondary cutting surface displaced from the blade body and extending up therefrom. There is an at least one lead cutting surface located on the secondary cutting surface. The lead cutting surface has at least one portion facing substantially forward toward said the primary cutting surface. The portion can be a tip portion, but is turned so that the tip breaks a perpendicular plane drawn up from the blade body and extending radially along the length of the blade body.

### CROSS REFERENCE TO RELATED APPLICATIONS

This application claims benefit of the earlier filed U.S. Provisional Application No. 60/334,610 filed Dec. 3, 2002, which is incorporated herein by reference.

### FIELD OF THE INVENTION

The invention relates to an improved cutting blade, particularly to a blade with a number of secondary cutting or mulching surfaces positioned facing forward toward a primary cutting surface so as to increase the surface area presented for mulching grass clippings during rotation of the blade, maximizing efficiency and minimizing labor, maintenance, and parts costs. Additionally, for use together or independently of the blade having secondary cutting surfaces, an improved blade system for mounting multiple blades in a mower and an improved blade hardening technique are disclosed.

### BACKGROUND OF THE INVENTION

A principal problem in the lawn maintenance industry is that grass clippings, leaves, twigs, and other lawn remnants or landscape materials are unsightly when left on the grass after landscape maintenance. So, whether mechanically or manually, these unsightly remnants are usually removed and disposed of, which is both costly and labor intensive. Typically, these remnants are bagged in plastic lawn bags. Fully 60% of the industry is still using bags to collect and dispose of generated clippings. Bagging often means more wear and tear on machinery and the added expense of hauling grass clippings to a compost or a disposal site, which boosts labor and fuel costs and wastes time. Time is money for the lawn maintenance contractor.

Bagging is also environmentally costly. For example, the average California lawn generates 300 to 400 lbs. of grass clippings per 1,000 sq. ft. annually, according to the California Integrated Waste Management Board. More than six million tons of these clippings, and the corresponding plastic bags, end up being hauled off lawns and disposed of through municipal waste programs, comprising approximately 15 percent of that state's waste. The volume of this waste nationwide was so significant that the Environmental Protection Agency was recently prompted to make yard waste its number one target for landfill bans, since grass clippings made up 20.1 percent of all solid landfill waste annually according to the Professional Lawn Care Association of America. As a result, grass clippings are now often banned from landfill disposal.

In addition to the added costs and environmental concerns associated with hauling and disposal methods, removal of the cut grass reduces nitrogen levels and increases the need to fertilize. Recent research at Ohio State University's extension department of horticulture and crop sciences has shown that when grass clippings are removed from a lawn, 20 to 25 percent more fertilizer is needed to maintain a certain level of color and quality in the lawn than when clippings are returned to the lawn. This increased need for fertilizer is required since the clippings contain measurable amounts of nitrogen, phosphorus and potassium. If sufficiently reduced in size, the clippings returned to the lawn do not contribute to thatch accumulation, and they decompose naturally, returning these nutrients to the soil. For instance, the estimated six million tons of clippings in California contain nearly all of the nitrogen necessary for healthy turf in the entire state. Thus returning the clippings is environmentally friendly in several ways, as it prevents usage of landfill space and unnecessary additional pollution attributable to hauling and disposal and it promotes natural fertilization.

In fact, various programs encouraging the recycling of grass clippings have developed nationwide to encourage the environmentally friendly practice of leaving the clippings on the lawn when mowing. However, this solution does not satisfy the average homeowner who wants a professionally manicured lawn. The sight of rows of unkempt grass clippings is not aesthetically pleasing to the consumer.

One way to remove the unsightly clippings without bagging is to manually rake into compost heaps on-site. Another is to double or triple cut turf to re-cut clippings so as to dispense them into the turf. However, this is both labor and equipment intensive. A solution lies in effective mulching.

Mulching, a process by which grass clippings are cut into smaller and smaller pieces and redistributed into the lawn to compost naturally, avoids unnecessary bagging and additional mowing by reducing the size of the grass clippings. Commercial mower manufacturers have tried to produce machines with mulching decks that keep the clippings in the mower deck area or in an additional mulching deck to tear up grass blades into tiny pieces and disperse them back into the grass. However, the cost of these additional machines for the limited use of mulching is not effective for many of those in the landscaping industry and is an especially undesirable purchase for the average homeowner.

Another mechanism to effectively achieve mulching of grass clippings at a greatly reduced cost is using a blade or blade kit that is specially modified to re-cut the clippings after the initial cut is made. The advantage of using mulching blades is that they can be inexpensively mated to a standard mower and mulch the grass clippings. There have been many different approaches to mulching blade designs, but most are engineered to cut and then re-cut the grass, leaving tiny clippings. The smaller the clippings are, the quicker they decompose. However, none of the known mulching blades has achieved a satisfactory reduction in clipping size. Additionally, especially troublesome both for the known mulching blade designs and standard mower blades is wet grass. When wet grass is cut it tends to clump on top of the turf bed and then needs to be double or triple cut, leading to increased costs in time, labor, maintenance and machinery. Similarly, effective mulching of leaves and other large pieces of lawn materials, such as hedge clippings, is especially difficult for the heretofore known blades.

Known blades include those disclosed in U.S. Pat. Nos. 5,515,670 and 5,291,725 to Meinerding. These are lawn mower blades with a plurality of shredders affixed to the blades. The shredders provide additional cutting edges for mulching. However, the cutting surfaces of the shredders trail back towards the trailing edge of the blade. These embodiments are not very efficient in mulching grass and are ineffective in mulching heavier yard material, such as leaves or wet grass. The grass clippings and especially the larger lawn materials simply ride up and over the secondary cutting surfaces which are angled rearwardly toward the trailing edge or adhere to the blades without being cut.

Another example of a blade with multiple cutting surfaces can be seen in U.S. Pat. No. 5,875,700 to Powell. This patent shows a circular brush cutting blade design with a series of peripheral cutting teeth. The cutting teeth are provided in a non-raised fashion around the periphery of the blade and a set of blades set in from the periphery are raised and similarly pointing in a directions that taper away from the direction of the rotation of the blade. Moreover, the blade design would not perform well in mulching grass clippings.

U.S. Pat. No. 4,559,769 to Seyerie provides for a cutting blade with a raised cutting sail. The angle of the sail does not point toward the primary cutting blade. Again full efficiency in cutting of grass clippings cannot be achieved from this embodiment, nor would this design be adequate to handle other lawn materials, as the materials would simply ride over the blade or adhere to the blade.

In yet another example of additional cutting surfaces, U.S. Pat. No. 5,581,987 to Schuyler discloses a mowing blade with a series of additional cutting edges affixed to the sail portion of the blade. Cutting edges are tipped upward, but their cutting edges do not bend or curve to face the primary cutting blade. Similar sail mounted cutting blades and blades that angle rearwardly toward a trailing edge can be seen in U.S. Pat. No. 5,353,581 to Rouse et al, U.S. Pat. No. 4,269,020 to Wolf, U.S. Pat. No. 3,998,037 to Deans et al., and U.S. Pat. No. 3,538,692 to Cope et al. These sail mounted blades and blades that angle rearwardly toward a trailing edge are inadequate for effective mulching, as the grass clippings just pass over the affixed blades affixed to the sails.

None of the heretofore known blades has been able to provide an efficient mulching blade for use with any mower deck and capable of reducing both grass clippings, wet grass clippings and other landscape remnants to a sufficiently mulched state that they can be effectively returned to the lawn.

There are also further drawbacks to these conventional mulching blades. Mowers mounting the conventional mulching blade systems have engines that require more horsepower to handle increased cutting volume, placing more demand on components, including blades, which may need to be sharpened more frequently. Similarly, with the increased load on the engine, more frequent and costly engine maintenance is required.

Additionally, although in heretofore known designs, attempts have been made to harden the facing of the cutting edge and provide multiple blade embodiments, none of these attempts have succeeded. Neither of these aspects has been adequately achieved by any of the heretofore known designs. For example, U.S. Pat. No. 5,879,743 describes a typical method for applying a chemical treatment to coat a cutting blade to make it wear resistant by hardening the cutting surface. However, these known surface treatment methods do not penetrate sufficiently into the blade to provide adequate hardening of the blade beyond a depth that would exceed the amount of metal removed during the first few sharpenings. This results in a blade that cannot present a hardened cutting surface after it is sharpened and, thereby, limits the life span of the blade. Furthermore, applying these known processes or other surface treatments sufficiently to affect the blade throughout would be ineffective, as it would make the blade brittle and subject the blade to potentially being shattered during use. Therefore, there exists a continued need for an effective method for hardening blades that are mounted on lawn equipment.

Similarly, attempts have also been made to provide multiple blade systems for lawn equipment. These attempts primarily involve dowel systems used to hold the blade in place, often by providing additional screws or dowels or using specially adapted arbors. For example, a multiple blade embodiment is shown in U.S. Pat. No. 5, 832,704 to Routh. The blade assembly is comprised of at least two blades, the blades being held in place by a series of dowel pegs. The heretofore known dowel and peg systems are overly complex and difficult to implement. These additional fastening mechanisms complicate the attachment procedure for the blades and further provide additional points of failure in the machine. Similarly, solutions utilizing specialized arbors are costly and complicated. Therefore, there exists a continued need for a simple, uncomplicated mechanism for securing multiple blades onto a standard mower spindle.

Thus, there remains a continuing need for more effective, efficient mulching blades that will chop landscape materials of all sorts into smaller pieces and disperse it evenly across the turf to fall out of sight and improve soil conditions, which will in turn require less nutrients and irrigation to achieve a quality looking lawn. Similarly a continuing need exists for a mulching blade or blade system that is more wear-resistant, puts less stress on a powerplant, can quickly and efficiently mount multiple blades, and can be quickly and easily attached to a conventional lawn mower.

### SUMMARY OF THE INVENTION

An object of the invention is to provide more effective, efficient mulching blades that will chop landscape materials into smaller pieces and disperse it evenly across the turf to fall out of sight and improve soil conditions.

An object of the invention is to provide a mulching blade, which is more wear resistant, requiring less sharpening, by applying hardened materials onto the blade.

An object of the instant invention is to provide a blade system, which is capable of achieving the same cutting efficiency at lower RPM through multiple blade configurations.

Further objects of the invention include extending the life of the equipment, reducing equipment maintenance cost, and conserving oil and gas.

Another object of the instant invention is to provide mulching blades, which operate at higher rates of speed.

Still another object of the invention is to provide a blade with an increased vacuum and discharge capability for removing excess debris that builds up. This is achieved by having several raised secondary cutting surfaces, which act like sails and increase lift in the mower deck, and are raised and curved forwardly to substantially point towards a primary cutting surface.

A further object of the invention is to provide blades with higher speeds and higher vacuums that will allow for more efficient and thorough cutting of the grass clippings and landscape materials into smaller pieces. This in turn results in quicker decomposition and a quicker return of nitrogen and other nutrients to the soil. This is achieved through secondary blades that are raised, providing a sail surface, and pointed substantially in the direction of rotation of the blade.

Yet another object of the invention is to provide a blade that, when mowing over freshly edged hardscapes (sidewalks rounds, etc.), has a vacuum that will be better able to pick up debris and discharge it to a turf area, which in turn will reduce blowing procedures and clean up.

A still further object of the invention is a blade and blade system with an increased ability to pickup and mulch hedge trimmings, thus reducing the need to rake and bag hedge trimmings and adding additional compost material into the turf, this being a result of having raised secondary cutting surfaces in conjunction with or solely with multiple blades attached to a single spindle.

A still further object of the invention is to cut grass clippings to a substantially smaller size so as not to leave unsightly clippings, this being accomplished through several secondary blade surfaces facing the direction of rotation of the blade and by presenting a series of cutting surfaces curving upwardly and forwardly toward the primary cutting surface.

Yet another object of the invention is a blade with an increased surface area to provide for initial cutting and increased secondary cutting or mulching of the grass clippings.

Still another object of the invention is a blade that more effectively and efficiently mulches or post-processes grass, leaves, small twigs and other landscape materials utilizing improved secondary cutting surfaces with increased surface area for cutting.

A still further object of the invention is a blade with improved mulching efficiency with secondary cutting surfaces that do not merge rearwardly to a trailing edge

Yet another object of the invention is a set of self-sharpening secondary blade surfaces that will reduce wear and tear on equipment by reducing the need for sharpening.

Still another object of the invention is a blade with hardened cutting surfaces produced by joining hardened cladding material to the primary blade to form the cutting surfaces, the hardened surfaces reduce maintenance costs, require less sharpening, and are longer lasting.

A further object of the invention is a blade system that reduces fuel and oil consumption

Still another object of the invention is a blade system that provides for multi-functionality by combining multiple blades having different cutting characteristics on a single spindle and without the need for additional hardware or specially shaped spindle/arbor.

Yet another object of the invention is a blade mounting system with multiple blades that are mounted at adjustable angles to one another.

Yet another object of the invention is a blade system with the option for crossing at least two blades that at least doubles the number of cutting surfaces.

A still further object of the invention is a blade system with the further option of crossing more than two blades to provide increased cutting efficiency and higher cutting volume.

Another object of the instant invention provides a blade system for mixing the blades to achieve different results according to the cutting environment and type of turf being cut.

Yet a further object of the instant invention is a blade system with more than one blade that requires less RPMs to achieve the same cutting efficiency and increases equipment life substantially.

Still a further object of multiple blades system which in turn uses even less gas and oil than standard systems to cut the same volume.

A still further object of the invention is better mulching through increased surface area for mulching on multiple blades.

A still further object of the invention is to provide lower RPMs in a mower, reducing the need for both maintenance and fuel costs, by increasing the number of blades on the spindle.

Yet another object of the instant invention is a multiple blade system with a higher vacuum and a higher consistency in mulching.

Another object of the invention is a reduction in thatch accumulation due to the high lifting forces/vacuum of the blade and blade system, which lifts thatch from the turf stand and mulches the thatch. The thatch is then returned to the turf as organic matter together with any additional mulched lawn materials.

The invention includes a method, an apparatus, and a system for cutting landscape materials to effectively effective mulch these landscape materials.

An exemplary apparatus of the instant invention includes a cutting blade comprising a blade body with a primary cutting surface and at least one secondary cutting surface cut from and displaced from said blade body and an at least one lead cutting surface on said at least one secondary cutting surface, said lead cutting surface being angled/curved/bent such that the tip of said cutting surface faces said primary cutting surface.

A further exemplary embodiment of the instant invention includes a blade for lawn equipment with cladding/facing material comprising a blade body with a first portion; and a separate portion of cladding/facing material attached/coupled to said first portion, wherein said cladding material is sharpened and is wear-resistant and attached to the lawn equipment.

### BRIEF DESCRIPTION OF THE DRAWINGS

Embodiments of the invention are explained in greater detail by way of the drawings, where the same reference numerals refer to the same features.

FIG. 1 shows a top view of an example of a typical mulching blade;

FIGS. 2A and 2B show top views of an exemplary embodiment of the instant invention;

FIG. 2C shows a top view of a further embodiment of the instant invention;

FIG. 3A shows a cross-sectional view of the exemplary embodiment of FIG. 2B of the invention along line A-A;

FIG. 3B shows an end view of the blade along the outer end of the exemplary embodiment of FIG. 2B;

FIGS. 4A and 4B show a further embodiment of the invention having a wear-resistant primary cutting surface;

FIG. 5 and FIG. 6 show an exemplary embodiment a novel blade mounting and interlock mechanism of the instant invention.

### DETAILED DESCRIPTION OF THE INVENTION

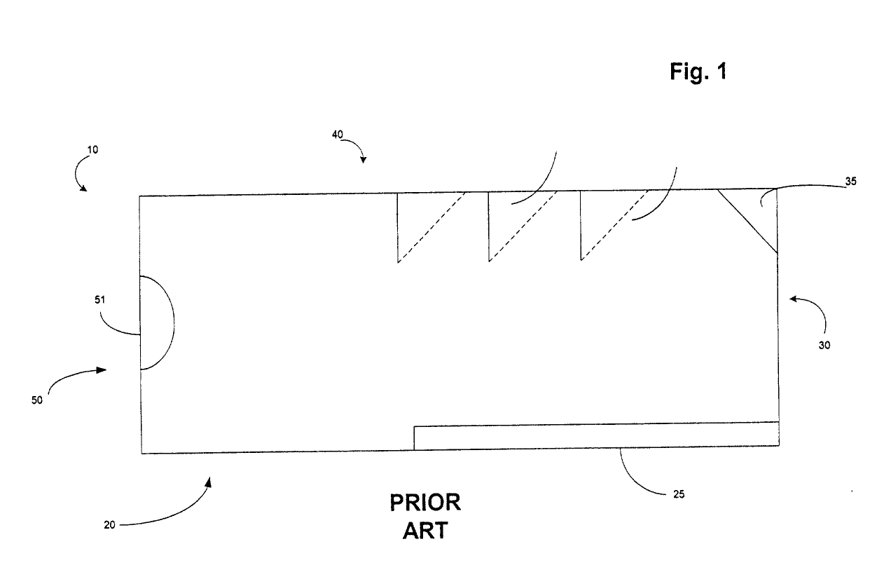

FIG. 1 shows a top view of an example of a typical mulching blade. For the sake of clarity, this patent refers to and depicts in the figures one side, or half of a full blade. It is clear to one of ordinary skill in the art that an identical and oppositely facing counterpart makes a complete blade. On the mulching blade, there are generally provided a set of additional sharpened edges. The additional edges provide for further cutting of the initial grass clippings as the clippings are passed over the blades multiple times while being suspended in the cutting chamber of the mower deck. As seen in FIG. 1, a conventional blade 10 has a leading edge 20 and a trailing edge 40. On the leading edge 20, a primary cutting edge 25 extends access a portion of the leading edge. The surface of cutting edge 25 typically ground with 45° bevel and provides the initial cut of the grass in a first cutting direction in a plane substantially parallel to the ground.

One end of the blade 10 is an outer end 30. Typically this end develops into a raised portion or sail portion 35. The sail portion 35 is typically upturned to maintain the continued circulation of the grass clippings. The sail portion 35 provides additional loft and keeps grass clippings in the housing airborne so as to be repeatedly passed over the primary blade and any additional blades. Additional aspects of heretofore known designs have included several modifications including for instance, increasing the number of blades by sectioning the trailing edge and up turning certain portions sometimes in an angular fashion, typically tapering away from the cutting edge. However, in all prior designs, the effective increase in the number of blades has not achieved sufficient post processing or mulching of the clippings.

The instant invention increases the maximum surface area presented for post processing or mulching of the grass clippings by at least 50%. The instant invention is therefore a much more effective and efficient mulching blade.

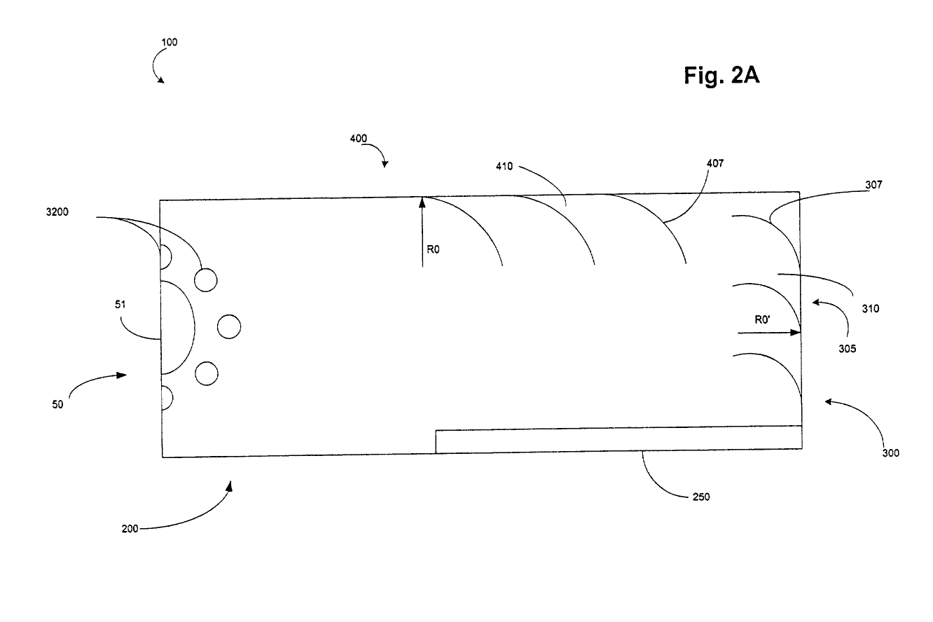

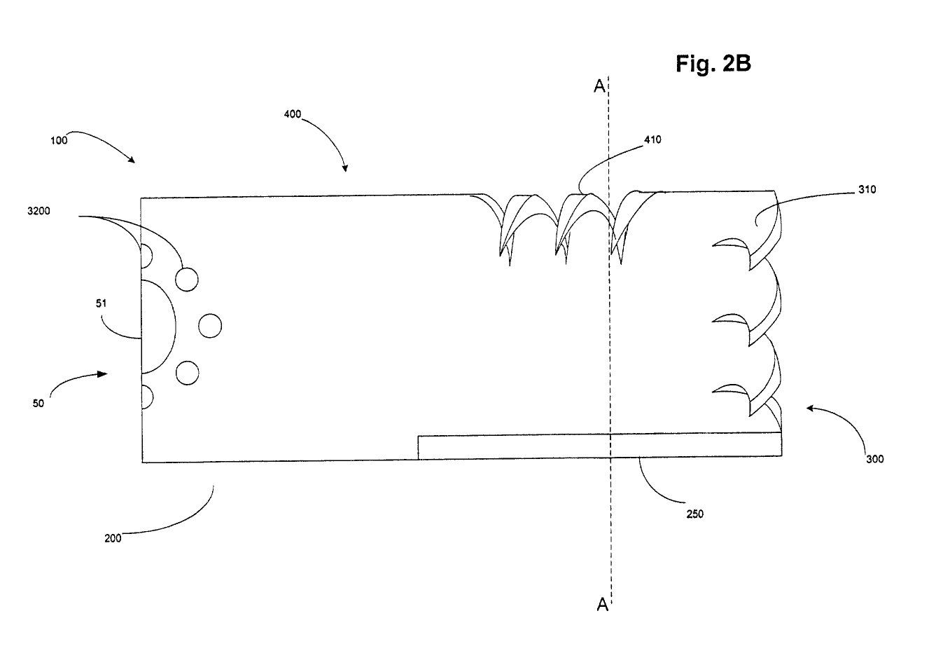

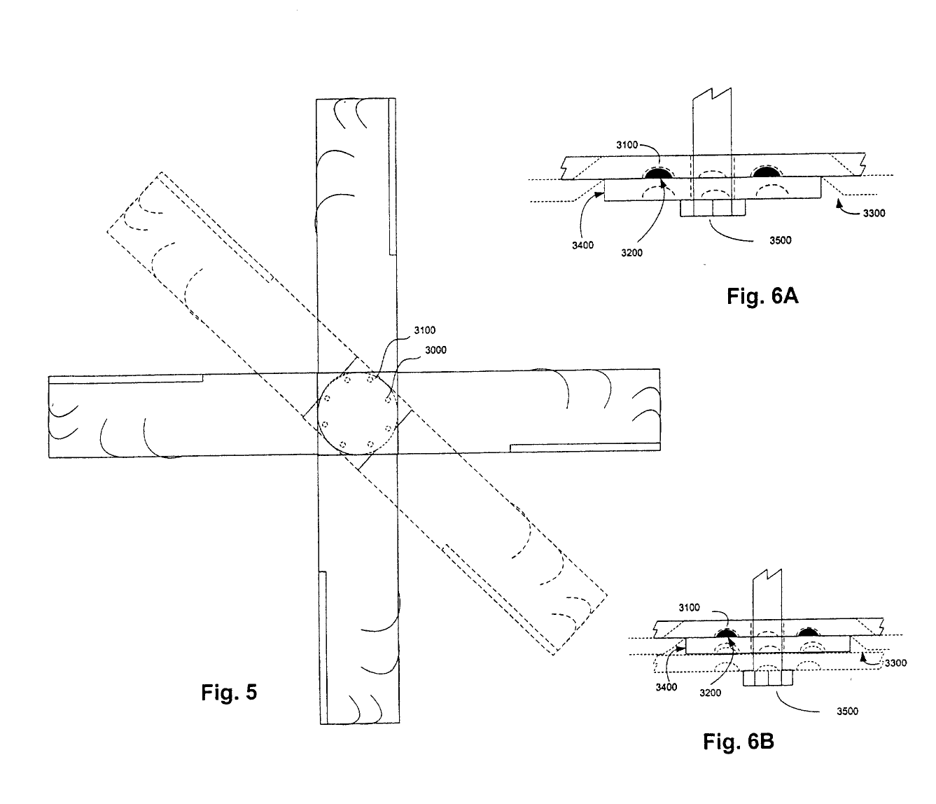

FIGS. 2A and 2B show top views of an exemplary embodiment of the instant invention. The exemplary embodiment of the instant invention has a blade body 100 rotating in a direction, either clockwise, as shown, or counter-clockwise, with a leading surface 200, a trailing surface 400 and an outer end portion 300 relative to the direction of rotation about the spindle 50. The blade includes a primary cutting surface 250 which is typically ground on a bevel to provide a sharpened surface, similar to standard blades. Also shown are protrusions 3200, part of a novel blade interlock system described below in relation to FIGS. 5 and 6.

Along a portion 405 of the trailing surface 400, a series of secondary cutting surfaces or mulching surfaces 410 are cut into the blade body 100, as seen in FIG. 2A, and then raised into position, as described below and seen in FIG. 2B. By cutting inward on a beveled angle 407 from the trailing surface 400, away from the spindle, at a radius RO, at spaced intervals along portion 405 of the trailing surface 400, the secondary cutting surfaces 410 are cut from the blade body 100. The beveled cuts 407 provide the raised secondary cutting surfaces 410 with a sharpened beveled edge when they are in the final raised position. The width of the beveled cuts can vary. The width of the cuts also controls retention of debris. The width is preferably between about 1/16 of an inch and ¾ of an inch.

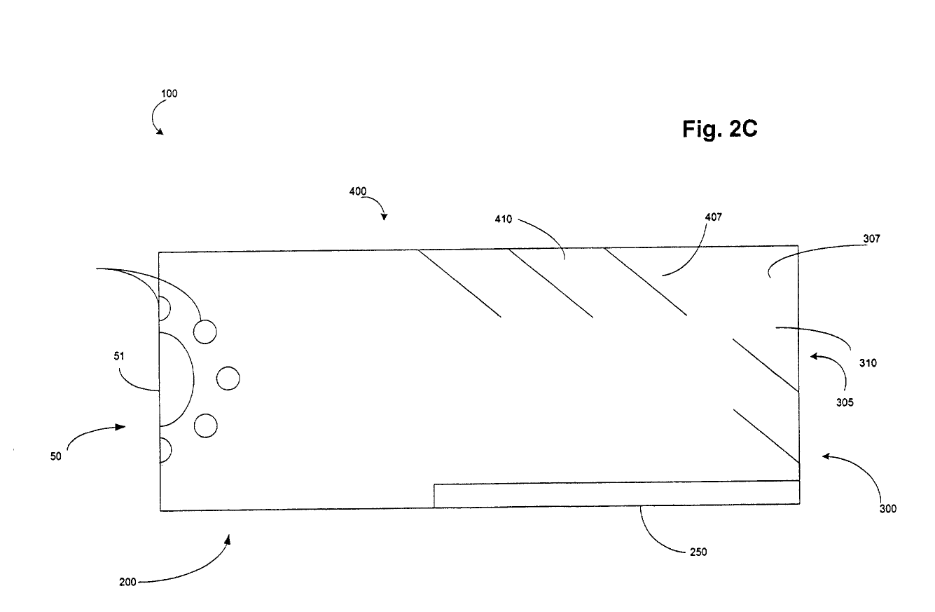

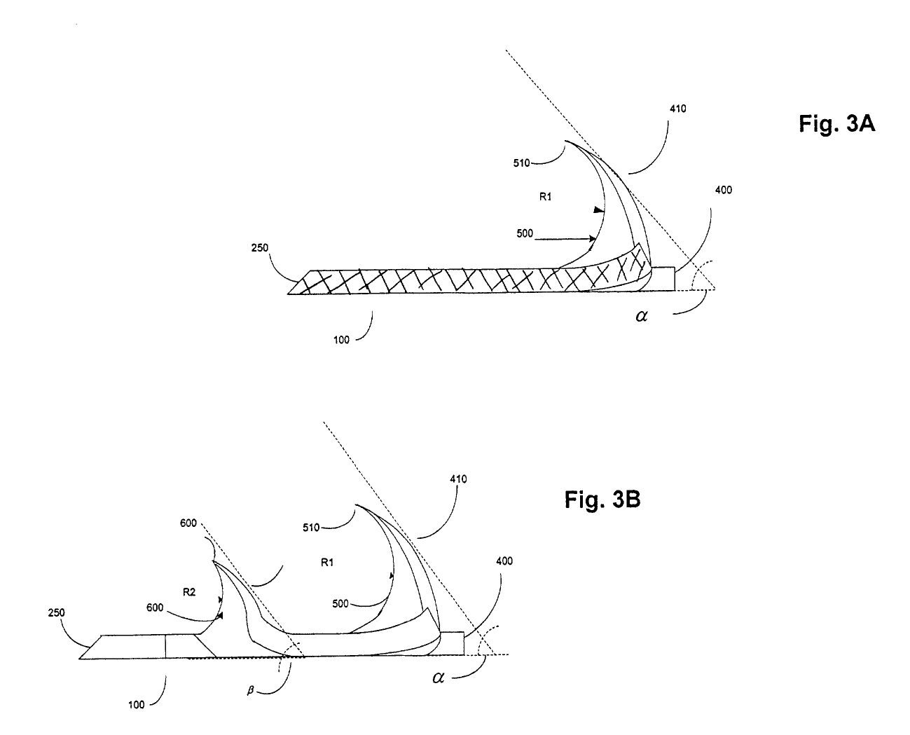

Each of the cuts 407 is raised from the blade body 100 such that the point at which the cut entered the trailing surface 400 is moved to a position facing substantially towards the primary cutting surface 250, as seen in FIGS. 2B, 3A, and 3B. This raised set of secondary cutting surfaces 410 are curved in the exemplary embodiment depicted and resemble a series of hooks, these provide for a dramatic increase in the effective cutting surface area and, thereby, the mulching performance of the blade over heretofore known designs. Although the curved surface provides for a larger surface area, a straight surface facing forwardly towards the primary cutting edge is not precluded, but the preferred curved surface maximizes cutting surface area and provides enhanced cutting characteristics as described below.

FIG. 2C shows a top view of a further embodiment of the instant invention. The blade is shown cut with substantially straight cuts 407. These cuts are then raised in a fashion similar to that described above with respect to FIG. 2B, showing the preferred curved secondary cutting surface. Alternatively, in other embodiments, the cuts could be made toward the spindle. However, these cuts provide less air circulation, as discussed below.

The secondary cutting surfaces are raised and angled forward. Angled forward includes any raked angle of the secondary cutting surface, portion of the secondary cutting surface, or tip portion up to and including a tip that points parallel to a plane that extends perpendicularly from the horizontal plane of the blade body and includes any position forward of that plane. As noted above, the surfaces may be raised from either straight or curved cuts in the blade. The cuts can be made facing inwardly or outwardly relative to the spindle, however, the preferred cuts are made inwardly to provide enhanced lift in the blade as each surface acts as a sail, as previously described. The secondary cutting surfaces may also be curved, which provides even further enhancements to the mulching properties as discussed inter alia.

The exemplary method for bending up or raising the secondary cutting surfaces 410, includes first bending a tip portion away from spindle 50 preferably to be substantially upright or at ninety degrees relative to the blade body 100, then rolling the entire secondary cutting surfaces 410 toward the primary cutting surface 250. Alternatively, in a further exemplary method utilizing a single bending motion, the secondary cutting surface is bent from the plane of the blade body upwardly, outwardly away from the spindle 50, and forwardly toward the primary cutting surface 250 to form the secondary cutting surface. Additionally, variations in the degree of rolling the secondary cutting surface upward, outward away from the spindle, and forward toward the primary cutting blade may be made without departing from the spirit of the invention. In fact, varying the degree of rolling upward and forward of the secondary cutting surface can vary the degree of lift or vacuum generated by the blade. In an exemplary embodiment of the apparatus of the invention and the method of production, the degree of rolling the secondary cutting surfaces upward can be varied between about 50 and about 100 degrees, and similarly the degree of rolling the secondary cutting surfaces outward from spindle can vary from about 10 degrees to about 130. Another exemplary embodiment can have a tip rolled so that the tip faces forward, that is the tip faces forward anywhere from and including 90 degrees relative to the horizontal plane of the blade body to a facing of 180 degrees forward relative to the blade body or parallel with the horizontal plane of the blade body and the tip is substantially upright relative to the blade body surface. In a further embodiment, the lift angle α of secondary surfaces can rise between 30 and 100 degrees upward with a corresponding forward roll such that a portion of the blade will face substantially forward, between and including about 90 degrees to about 170 degrees forward relative to the leading edge of the blade.

The direction and position of the secondary cutting surfaces, facing opposite the direction of travel of the blade rather than tapering off in the direction of travel, enhances the further cutting or mulching of the grass clippings as they are repeatedly passed over the raised, preferably curved surfaces. The preferred curved surface also promotes air movement to help prevent clumping of wet grass clipping and other landscape remnants on the blade or in the mower. Each of the raised surfaces also acts to direct cuttings over other secondary cutting surfaces, similar to a sail in a conventional blade, thus further enhancing the mulching or post-processing of the clippings. In addition to lifting and mulching the grass, the invention also provides a significant vacuum that assists in lifting larger pieces of lawn materials and thatch from the turf stand. Once lifted from the turf stand the thatch and lawn materials are mulched and returned to the turf as organic matter in the same fashion as the grass clippings.

Similar to the set of secondary cutting surfaces 410 on the portion of the trailing surface of the blade 400, an at least one similar outer secondary cutting surface or outer mulching surface 310 is located on a portion 305 of the outer end 300. Although all the secondary cutting surfaces described herein in regards to the exemplary embodiments depicted in the figures utilize portions of the trailing surface or the outer end portion, the entire length of these parts of the blade body may be utilized in the instant invention as well.

Along the portion of the first end 305, the at least one outer secondary cutting surface 310 is raised from the blade body. By cutting at least one beveled cut 307 in an inward fashion from the first end 300 toward the spindle at a radius R0′, the at least one outer blade 310 is cut from the blade body 100 in a manner similar to the previously described secondary cutting surfaces 410. These at least one cut 307 is also beveled, which provides the raised at least one outer blade 310 with a sharpened edge when in the raised position. Each of the at least one cuts 307 is raised from the blade body 100 such that the point at which the cut enters the outer end 300 is moved, similar to the secondary cutting surfaces 410, to a position facing substantially towards the primary cutting surface 250, as better seen in FIG. 3B. Similar methods are also used to bend the at least one outer secondary cutting surface 310 from the blade.

FIG. 3A shows a cross-sectional view of the exemplary embodiment of FIG. 2A of the invention along line A-A. In this view, the end of the blade body 100 having the upturned cutting surfaces is shown in detail. A blade body 100 having a forward leading surface 200 and a primary cutting surface 250 is shown. The secondary cutting surfaces 410 are shown in a raised position, rising inboard of the trailing surface 400 of the blade in this cross-sectional view along line A-A. The raised secondary cutting surfaces 410 can be raised by, for instance, at an angle alpha or lift angle. Angle alpha can range from about 10 degrees to about 85 degrees upwardly. Preferably, angle alpha is about 65 degrees upwardly from the horizontal plane of the blade body. This angle is separate from the forward roll of the secondary cutting surface. The forward roll of the cutting surface provides a secondary cutting surface facing substantially forward or toward the primary cutting surface.

As seen in FIG. 3A, the secondary cutting surfaces 410 provides a lead cutting edge or lead cutting surface 500 having a tip portion 510, the leading cutting surface 500 having a curved or angled cutting surface with an approximate radius of about RI. The tip portion 510, which was part of the portion of the trailing surface 405, is bent to substantially face the direction of rotation of the blade and the primary cutting surface 250.

The lead cutting surface 500 of the secondary cutting surfaces 410 are sharpened, as mentioned above, by the fact that the initial cut 407 is made on a bevel. This provides a sharp angular cutting face for the secondary cutting surfaces 410, which is pointed in the direction of the motion of the blade. All of the secondary cutting surfaces are similarly cut at a bevel. This bevel cut can range from about 10 degrees to about 85 degrees, but is preferably about 45 degrees. This provides a pre-sharpened cutting edge. These edges are also self-sharpening. The majority of debris passing over the edges will help to promote the continued presentation of the sharpened beveled angle in the secondary cutting surfaces. The clippings pass along the raised sail-like portion of the secondary cutting surface wherein the leading edge and face of the sail like portion, thus maintaining a sharp edge.

As can be seen in FIG. 3A, once the initial cut is made by the primary cutting blade 250 at the leading surface 200 of the blade, the clippings are then immediately passed over the radially curved cutting surface 500 which provides a vastly increased cutting surface, on the order of 50% greater than the heretofore known mulching blades. For instance, by comparing a blade having the heretofore known protrusions, that is one having protrusions cut at 90° to the trailing surface and raised so that the protrusion tapers toward the trailing surface at 45°, and the other having the secondary cutting surfaces of the instant invention the approximate increase in the surface area presented for mulching in the instant invention can be shown. Presuming a 1-inch long 45° angled cut, and having a thickness of a blade of one-eighth of an inch, the surface area presented along the front half of the standard blade for cutting would be approximately 0.125 square inches. While the equivalent cut, made with a bevel, in the instant invention and raised as described above would present approximately 0.19625 square inches of cutting surface based on a radius of approximately 1 inch for providing the curvature of the aforesaid cutting surface of the blade.

The preferred secondary cutting surface can be described as two circles intersecting one another at a single tangent point at the tip portion of the secondary 410 cutting surfaces, providing a first radius of curvature for an upper portion and a second radius of curvature for a lower portion. The two radii defining the secondary cutting surface from the shared target point, at the tip of the surface then descend to the blade body in approximately a quarter of the circumference of each of the circle. The secondary cutting surfaces can also be circular, ovoid, elliptical or rounded in general shape or appearance. In addition to the increase in surface area, the aggressive forward facing of the raised secondary cutting surfaces provides an increased duration of contact with the clippings and, therefore, an increased likelihood of additional cutting, as mentioned above. Since the blades curve forward the grass clippings are more likely to be forced over a cutting edge than if the cutting surface tapers to the trailing edge.

FIG. 3B shows an end view of the blade along the first end portion of the exemplary embodiment of FIG. 2A. An angled at least one outer secondary blade surface 310 having a radius R2 is shown, wherein the cutting surface provides a leading cutting edge or cutting surface 600 having a tip portion 610. The tip portion 610, which was part of the first end portion 301, is bent to substantially face the direction of rotation of the blade and the primary cutting 250 surface. The cutting surface 600 of the at least one outer secondary cutting element 310 is sharpened by the fact that the initial cut is made on a bevel. This provides a sharp angular cutting face pointed in the direction of the motion of the blade that is self-sharpening. The clippings are passed over these surfaces as well after the primary cut is made, further increasing the cutting surface area presented by the blade and further improving the mulching attributes of the blade over heretofore known designs.

The raised at least one outer secondary cutting surface 310 and secondary cutting surfaces 410 also provide for added lift. The degree of lift is increased depending on the angles β and α, respectively. The lift of the blade works to effectively keep the grass clippings raised off the grass and in the cutting chamber of the mowing deck. The secondary blades may be raised at an angle α as described above. The at least one outer secondary cutting surface 310 is raised at angle β from the blade body. The angles of lift of the outer secondary surfaces are limited in a similar fashion to said secondary surfaces, limited by the width of the blade and the height of the mower deck. Preferably this degree of rise will be between 30 and 100 degrees upward with a corresponding forward roll such that a portion of the blade will face substantially forward, between and including about 90 degrees to about 170 degrees forward relative to the leading edge of the blade.

With the additional cutting surface, provided by the curved secondary cutting surfaces 410 and the at least one outer secondary cutting surface 310, a more thorough mulching of grass clippings and landscape materials cut by the primary cutting surface blade 250 is possible. Modifications to the placement, shape and surface area of the cutting surfaces are possible without departing from the spirit of the invention. These modifications can include, for example increasing or decreasing the height of the secondary surfaces, increasing or decreasing the width of the cuts into the blade body, increasing or decreasing radius of curvatures, increasing or decreasing the offset of the sharpened beveled edge of the secondary cutting surface and tip relative to the blade body, increasing or decreasing the bevels of the cut that is made to release the secondary cutting surfaces from the blade body portion, thereby varying the blade facing and other variables that would be evident to one of ordinary skill in the art. These ranges provide exemplary results in cutting. These values are provided as examples and should not be considered limiting.

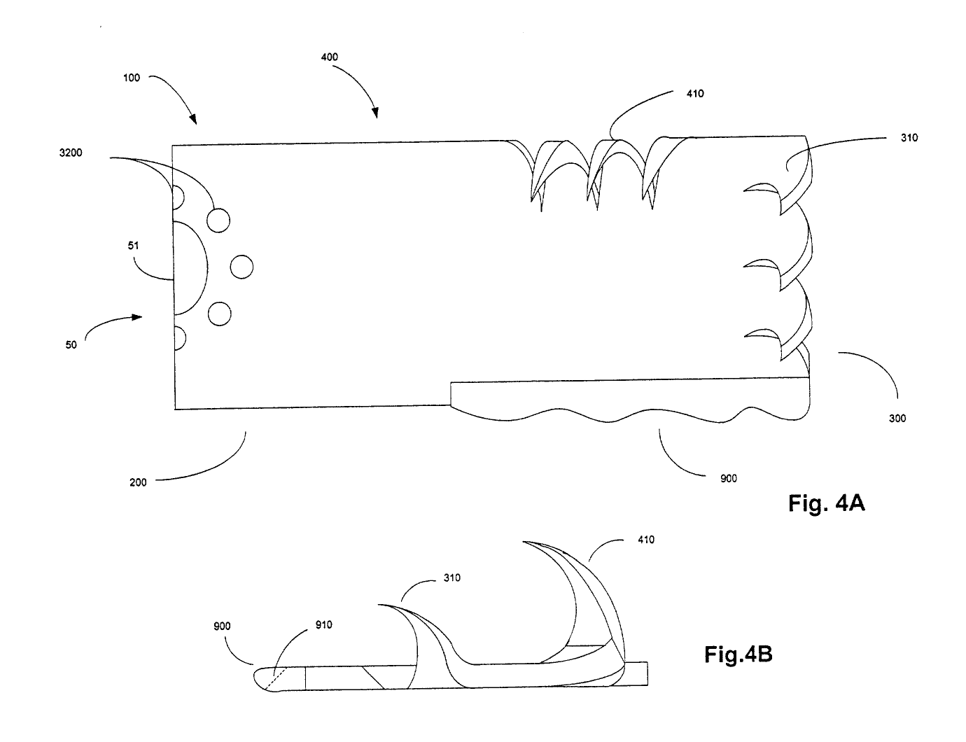

FIGS. 4A and 4B show a further exemplary embodiment of the blade with cladding material. Further improvements in the durability of the blade can be achieved in the blade system by applying cladding material onto the primary cutting surface of the blade. Cladding material 900 is applied to the primary blade cutting surface in conjunction with or alternatively to the secondary blade surfaces, the multiple blade system, or the other aspects of any of the other exemplary embodiments of the blades of the instant invention. The cladding is preferably a hardened steel or hardened steel alloy. For example, an exemplary alloy is the material used in welding electrodes and commercially available under the trade name HardAlloy 116 and manufactured by Mackay Welding Products. The electrodes comprise iron, manganese, silicon, titanium dioxide, calcium, chromium, magnesium, and nickel. The cladding material 900 is applied to the blade via an attachment process, preferably welding, and then ground to a 45-degree bevel to a cutting surface 910 (shown in dashed lines).

An exemplary method of applying the cladding begins with removing a portion of the leading surface 200 of the blade body 100. The process then applying at least one bead of cladding material via a welding process. Then the blade ground and the hardened primary cutting edge 910 is finished on the blade for use in lawn maintenance equipment. Other exemplary processes may utilize an insert of cladding material attached via a welding process or through another hot or cold working process. Additionally, in another exemplary method, a milled blade body may be milled or forged with a portion of the cladding material near the leading edge of the blade or along the entire leading edge of the blade. Additionally, the cladding may be run along both leading and trailing edges of the entire blade body. Some forms of welding that may be used, for example, include TIG, MIG, laser, or arc welding. By utilizing a low carbon steel, the likelihood of the cladding material shattering is reduced. However, any hardened steel within is sufficiently shatter resistant may be utilized.

The cladding reduces the need to sharpen the clad cutting surfaces. A reduced need for removing and sharpening the blade reduces the chance that the blade may be sharpened incorrectly and, thereby, adversely affect the balance. Imbalances in the blade lead to increased wear and premature failure of the bearings, casters and other parts that rotate the blade.

FIGS. 5 and 6 show an exemplary embodiment of a novel blade mounting and interlock mechanism also of the instant invention. The blade interlock mechanism 3000 is a further improvement, that can be used in conjunction with the aforesaid embodiments of the instant invention or separately in conjunction with heretofore known blade designs. The blade interlock mechanism 3000 comprises of a series of pre-positioned recesses 3100. The recesses are preferably indentations, but can be cut fully through the blade. These recesses mate with corresponding protrusions 3200 at specified angles, so that the blade system can mount additional blades on a single spindle 50 with a single attachment mechanism 3500, in the exemplary embodiment depicted, and still allow the angle between the blades to be adjusted. The recesses and protrusions depicted in the exemplary are rounded, although any shape may be utilized including tabs for insertion in corresponding slots.

The exemplary embodiment of the system is shown having two blades on a single spindle, the blades being separable at several angles, preferably at least at a first and second angle, for instance at 45 or 90 degrees to one another. Although two blades are depicted, embodiments having three and greater numbers of blades are contemplated. Further, a blade system allowing for several different types of blades could be combined to suit any mowing environment or type of turf. Additionally, the system may incorporate a modification of a main blade 3300 with bend that raises to accommodate a matching blade 3400 on the same cutting plane at any of the preset angles in the above mentioned interlock mechanism. Thus the system can include multiple mulching blades to provide for over a 100% increase in the surface area available for mulching when used in conjunction with the blades of the instant invention. Alternatively, it could combine a mulching blade and a standard blade or a high lift blade.

As a system, the exemplary system of blades with the interlock mechanism would reduce wear and strain on the engine of mowers by operating at one-half the current required RPM to do the equivalent amount of cutting. Additionally, the blades would be passed over the grass clippings twice as often, resulting in an even further increase in mulching capacity.

The embodiments and examples discussed herein are non-limiting examples. The invention is described in detail with respect to preferred or exemplary embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

1. An improved blade as substantially described herein and shown in the accompanying figures.

2. An improved attachment mechanism for interlocking at least two blades, as substantially described herein and shown in the accompanying figures.

3. An improved method of cladding a blade for use in landscape equipment, as substantially described herein and shown in the accompanying figures.

4. A cutting blade comprising:
a blade body with a primary cutting surface and a direction of rotation;
at least one secondary cutting surface displaced from said blade body; and
an at least one lead cutting surface located on said at least one secondary cutting surface, said lead cutting surface having at least one portion facing substantially forward toward said primary cutting surface.

5 The cutting blade of claim 4, wherein said lead cutting surface is curved.

6. The cutting blade of claim 5, wherein said at least one portion of said cutting surface is a tip portion.

7. The blade of claim 6, further comprising an upper portion of said secondary cutting surface, wherein the lead cutting surface can be defined by a first circle with a first radius and said upper portion can be defined by a second circle with a second radius, the first and second circles sharing a tangent point at said tip portion.

8. The blade of claim 4, wherein said lead cutting surface is elliptical, circular or rounded.

9. The blade of claim 4, wherein said blade body rotates in said direction of rotation on a spindle mounted on a central axis of said direction of rotation.

10. The blade of claim 4, wherein said at least one secondary cutting surface further comprises a row of cutting surfaces extending from a trailing portion of said blade body relative to the direction of rotation.

11. The blade of claim 8, wherein said at least one secondary cutting surface further comprises an additional row of secondary cutting surfaces extending from an outer portion of said blade body, relative to the spindle.

12. The blade of claim 5, wherein said lead cutting surface is curved along an at least one radius.

13. The blade of claim 12, wherein said secondary cutting surface is curved along a constant radius.

14. A cutting blade mounted on a piece of lawn equipment comprising:
a blade body mounted to a piece of lawn equipment with a primary cutting surface;
at least one secondary cutting surface cut from and displaced from said blade body; and
an at least one lead cutting surface having a tip portion located on said at least one secondary cutting surface, said lead cutting surface being curved such that the tip portion of said cutting surface faces substantially forward toward said primary cutting surface.

15. A method of making secondary cutting surfaces in a blade, comprising:
cutting inwardly from an edge of a blade body, the cut being away from a mounting spindle mounting said blade body;
bending a tip portion of the surface resulting from said cut away from said spindle and upwardly relative to the blade body; and
rolling the secondary cutting surfaces towards a primary cutting surface.

16. A method for making a cutting blade for mounting in lawn equipment, comprising the steps of:
cutting inwardly from an edge of a blade body and away from a mounting spindle that is mounting said blade body on the lawn equipment;
bending a tip portion of the surface resulting from said cut away from said spindle and upwardly relative to the blade body; and
rolling the secondary cutting surfaces towards a primary cutting surface.

17. The method of claim 16, wherein the tip portion is preferably bent upwardly to a substantially ninety degree angle relative to a horizontal plane of the blade body.

18. The method of claim 16, wherein the step of rolling further comprises rolling said secondary surfaces substantially forward toward said primary cutting surface.

19. The method of claim 16, wherein the step of rolling further comprises rolling said cutting surfaces forward toward said primary blade such that a tip portion of said secondary cutting surface brakes a plane extending radially from said spindle and being perpendicular to the blade body.

20. The method of claim 16, wherein the step of rolling further comprises rolling said cutting surfaces forward toward said primary blade such that a tip portion of said secondary cutting surfaces faces said primary cutting surface at an angle of at least between 90 and 180 degrees.

21. The method of claim, wherein the step of rolling said cutting surfaces further comprises rolling said cutting surfaces forward toward said primary blade such that a tip portion of said blade is facing toward said primary cutting surface at angle of about 90 degrees to about 180 degrees relative to the blade body.

22. A method of making secondary cutting surfaces in a blade, comprising:
cutting a radial cut in a blade body away from a mounting spindle; and
bending, in a single bending motion, a secondary cutting surface from a blade body, the secondary cutting surface being bent simultaneously upwardly from the plane of the blade body and outwardly away from a spindle and forwardly toward a primary cutting surface to form secondary cutting surfaces.

23. A lawn equipment blade with hardened facing material comprising:
a blade body with a first portion; and
a portion of hardened facing material coupled to said first portion, wherein said hardened facing material is sharpened and is wear-resistant.

24. A method of applying the a hardened cutting surface on a lawn equipment blade, comprising the steps of:
removing a portion of a leading surface of a blade body;
applying a hardened material to said leading surface, along the removed portion; and
grinding the hardened material into primary cutting edge.

25. The method of claim 24, wherein the hardened material is attached by a welding process.

26. The method of claim 24, wherein the hardened material is attached by a hot or cold working process.

27. The method of claim 24, further comprising a milled blade body, milled or forged with a portion of the cladding material near the leading edge of the blade or along the entire leading edge of the blade.

28. The method of claim 24, wherein the cladding is run along both the leading and trailing edges of the entire blade body.

29. The blade of claim 1, the blade having an at least one outer secondary cutting surface and a plurality secondary surfaces raised from a trailing edge of said blade.

30. A multiple blade mounting system, comprising:
at least two lawn equipment blades;
at least one spindle; and
at least two sets of protrusions rising from the blade and a corresponding number of recesses in the blades for engaging said corresponding number of protrusions, the protrusions being spaced to provide securement of the blades in at least two different angles relative to one another.

31. The blade mounting system of claim 30, wherein said at least two different angles comprise a first and a second angle.

32. The blade mounting system of claim 30, wherein said first and second angle include 45 and 90 degrees to one another.

33. The blade mounting system of claim 30, wherein three or more blades are attached.

34. The blade mounting system of claim 30, wherein several different types of blades are mounted.
